(19) United States
(12) Patent Application Publication
(10) Pub. No.: US 2004/0078229 A1
(43) Pub. Date: Apr. 22, 2004

(54) System and method of managing electronic medical records

(75) Inventors: Larry Gay, San Antonio, TX (US); Daniel Shelton, San Antonio, TX (US); Joel Sprowls, Boerne, TX (US)

Correspondence Address: William B. Nash, JACKSON WALKER L.L.P., Suite 2100, 112 E. Pecan Street, San Antonio, TX, 78205, US

(73) Assignee: Conceptual Mindworks, Inc.

(21) Appl. No.: 10/448,665

(22) Filed: May 30, 2003

Related U.S. Application Data
(60) Provisional application No. 60/384,455, filed on May 31, 2002.
(60) Provisional application No. 60/406,595, filed on Aug. 28, 2002.

(51) Int. Cl. G06F 17/60

(52) U.S. Cl. 705/2

(57) ABSTRACT

The present invention provides a medical record management system and method capable of providing patients and CDOs with secure access to medical information. In one embodiment, medical records are created, maintained and stored in one or more databases. In one embodiment, the database(s) are located apart from participating CDOs such that electronic data may pass between them through one or more computer networks. The present invention further provides a Health Employer Data and Information Set (HEDIS) rules engine capable of cataloging, retrieving and storing recommended treatments and/or procedures for individual patients. The present invention is capable of accessing this information in order to remind the physician, nurse, administrator and/or patient of recommended treatments and/or procedures.

This patent application claims priority upon 1) U.S. provisional application Serial No. 60/384,455, entitled System and Method of Managing Electronic Medical Records, having a filing date of May 31, 2002, and 2) U.S. provisional application Serial No. 60/406,595, entitled Electronic Medical Records Management System, having a filing date of Aug. 28, 2002.

### FIELD OF THE INVENTION

This invention relates to computer systems for managing and controlling access to patient information, and more particularly, to a computer system for securely providing the medical industry with complete, accurate and accessible medical records.

### BACKGROUND OF THE INVENTION

Health care providers recognize that the effective storage, retrieval and management of patient information is required to provide effective and efficient health care services. Care Delivery Organizations (CDO) are faced with increased pressure from competitors while government regulations and payor requirements continue to increase in complexity. The effective management of patient information typically causes an increase in the quality of patient care due to the fact that complete, timely and accurate information is readily accessible to the treating physician. Full and accurate knowledge of the patient's prior medical history, current medications, drug allergies, recent medical test results, etc., aids the treating physician in diagnosing the patient's condition in a cost effective manner.

Access to complete patient information is particularly important for patients who are not able to speak for themselves. Even conscious and alert, many patients may not recall the specifics of their medical history and/or recent treatments. Still fewer patients recall the results of recent medical tests. For such reasons, health care providers have invested considerable effort in the technologies related to the computerization and sharing of medical data and information.

Increased pressure on CDOs has forced many out of business and physicians out of the practice of medicine. Thus, identifying new opportunities for revenue while improving the relationship between the physician and the patient are critical to the practice of medicine. Additional HIPAA regulations are expected to increase the liability associated with the handling of patient medical information, consequently, the practice of medicine will change as a result. Initially, this will increase the cost of providing health care.

There remains a need for a medical record management system capable of 1) providing the medical industry with complete, accurate and accessible medical records, and 2) providing medical reminder information in a manner that assists the patient in making an informed decision.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing, wherein:

FIG. 1 is a process flow diagram illustrating one embodiment of the present invention in which one or more object oriented storage devices are electronically connected to a CDO via a local or wide area computer network.

FIG. 2 is a component diagram illustrating a data center hardware configuration utilized in one embodiment of the present invention.

FIGS. 3-20 are screen shots illustrating various aspects of the graphic user interface of one embodiment of the present invention.

FIGS. 21 and 22 are process flow diagrams illustrating the seamless backup capability system of one embodiment of the present invention.

### SUMMARY OF THE INVENTION

The present invention provides a medical record management system capable of providing patients and CDOs with secure access to medical information. In one embodiment, medical records are created, maintained and stored in one or more databases. In one embodiment, the database(s) are located apart from participating CDOs such that electronic data may pass between them through one or more computer networks.

To access electronic medical records, the physician, nurse, and/or administrator at the CDO need only input patient identifying information into the system. Once requested, the electronic medical record is copied, encrypted and transmitted to the CDO through a computer network. The present invention allows individual patients to communicate with the CDO via a patient portal capable of providing secure, HIPAA compliant, easily structured requests.

In addition to providing electronic medical records, the present invention provides physicians with valuable reminder information. In one embodiment, the present invention is capable of reviewing physician coding instructions and suggesting additional testing and/or procedures to support one or more codes provided by the physician. In another embodiment, the present invention provides one or more databases containing patient guideline information that may be used to provide reminder messages for suggested medical procedures and/or treatments. As a result, the present invention is capable of enhancing CDO efficiency by encouraging accurate code entry and proactive reminders of suggested medical services.

### DETAILED DESCRIPTION OF THE INVENTION

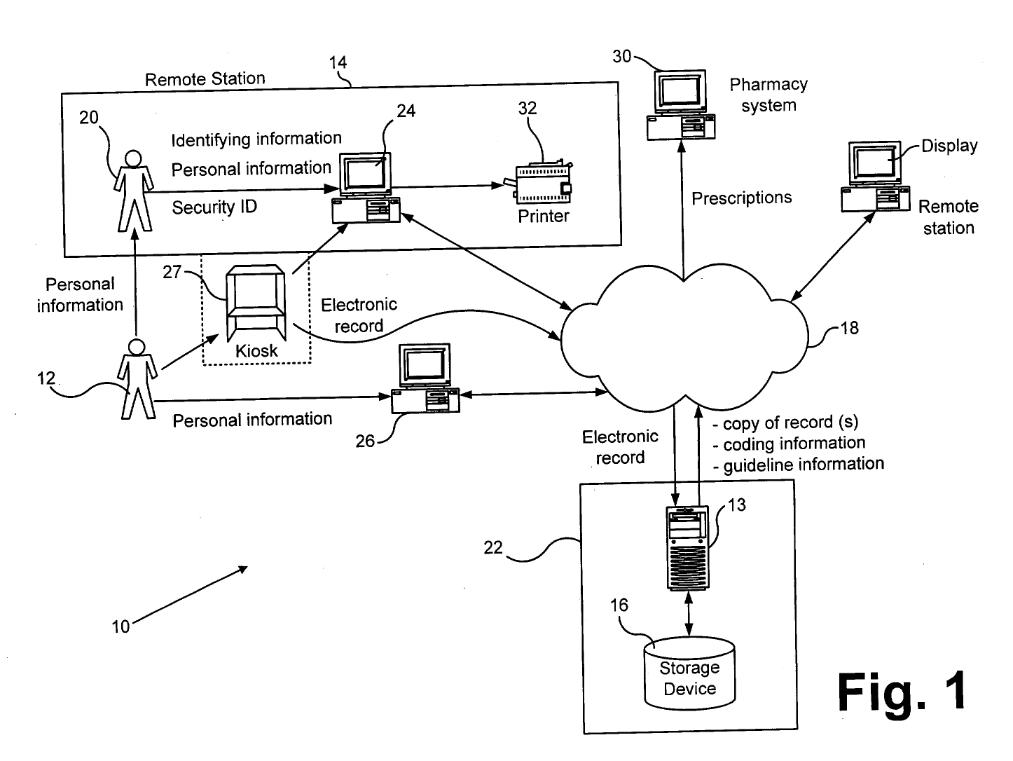

The present invention is herein described as a computer system for managing electronic medical records and as a method of managing electronic medical records. The present invention provides a medical record management system (10) capable of providing patients (12) and CDOs (14) with secure access to medical information. Referring to FIG. 1, in one embodiment, medical records are created, maintained and stored in one or more object oriented databases (16). In one embodiment, the database(s) are located apart from participating CDOs (14) such that electronic data may pass between them through one or more computer networks (18). Each database (16) being electronically connected to its corresponding CDO (14) with a multiple redundant infrastructure to ensure access.

In one embodiment, one or more databases (16), housed within one or more data centers (22), are electronically connected to the CDO (14) via a local or wide area computer network (18). Each data center may be equipped with one or more computer systems, information storage facilities, local service providers and other individuals trained to support participating CDOs.

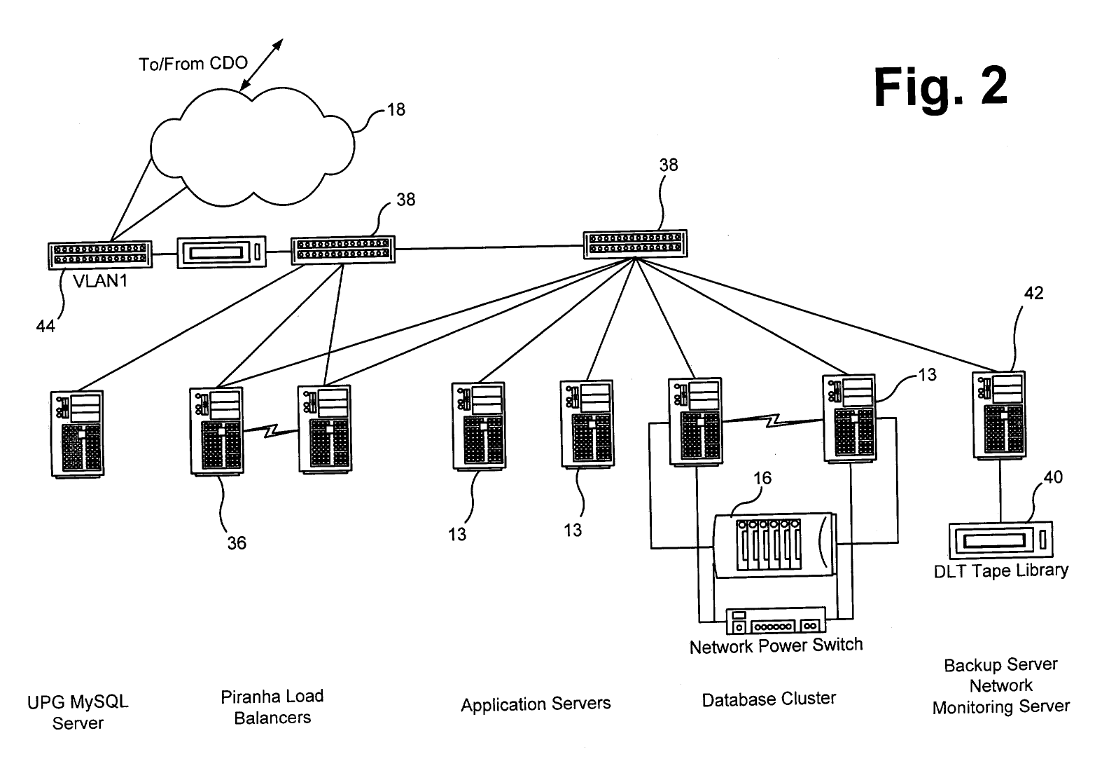

Referring to FIG. 2, the data center (22) hardware configuration may utilize any number of known systems to provide for data storage, secure access, and receipt/transmission of electronic records. Further, each data center may be equipped with multiple processing units (13) to ensure redundancy and backup capability, depending upon capacity/usage parameters. FIG. 2 illustrates one configuration that may be utilized to manage electronic medical records according to the invention described herein.

The embodiment shown in FIG. 2 utilizes a plurality of application servers to collect and process information received over the computer network (18). In one embodiment, one or more application servers are coupled to a cluster of storage devices (16) capable of storing electronic data. Further, one or more switching mechanisms (38) may be utilized to facilitate data transmission between the application server(s) and the network (18). In one embodiment, a Cisco Catalyst® 2950 series Ethernet platform is utilized to provide for secure network traffic management. These switches are capable of supporting 10, 100, or 1000 Mbps negotiated Ethernet interfaces or ports (not shown). In one embodiment, the present invention utilizes full duplex negotiation at a speed of 100 Mbps.

Optionally, the present invention may also utilize a virtual local area network (VLAN) (44). VLAN configurations are often utilized to increase the overall network performance by grouping users and resources that communicate most frequently with each other. Load balancers (36) may also be utilized to provide dynamic ranking of server activity across multiple servers from a single location. In one embodiment, one or more Piranha® load balancers are utilized. The present invention may also utilize a secondary database for backup and restore capability. In one embodiment, a Hewlett Packard® DLT tape library (40) is utilized along with an accompanying backup server (42).

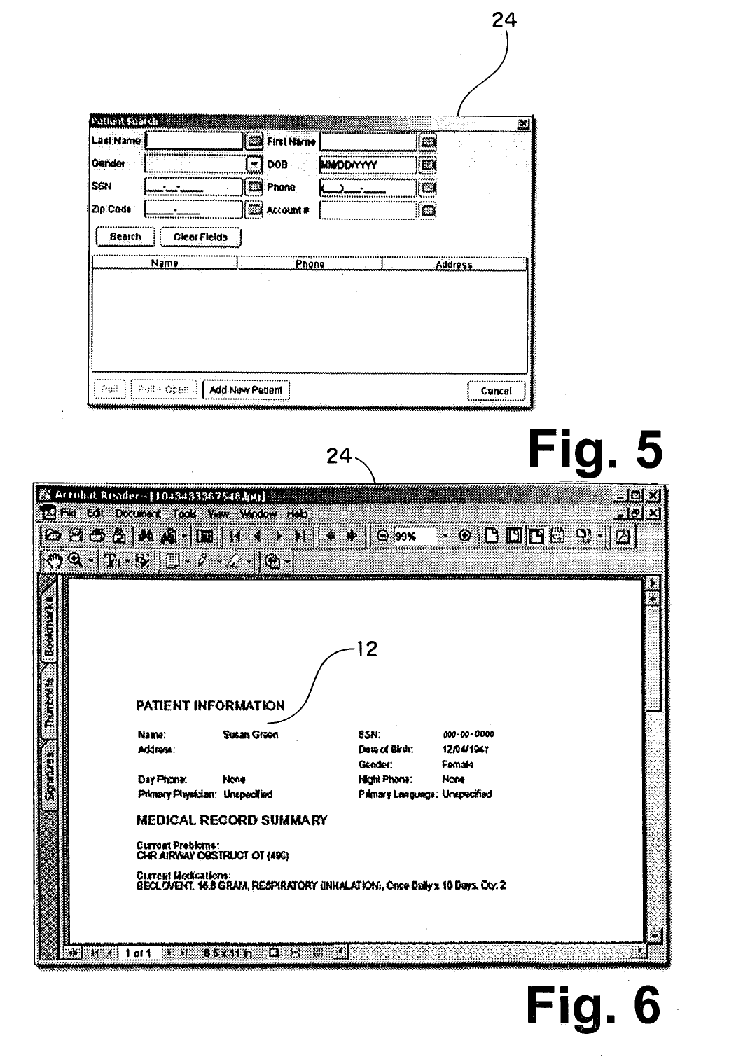

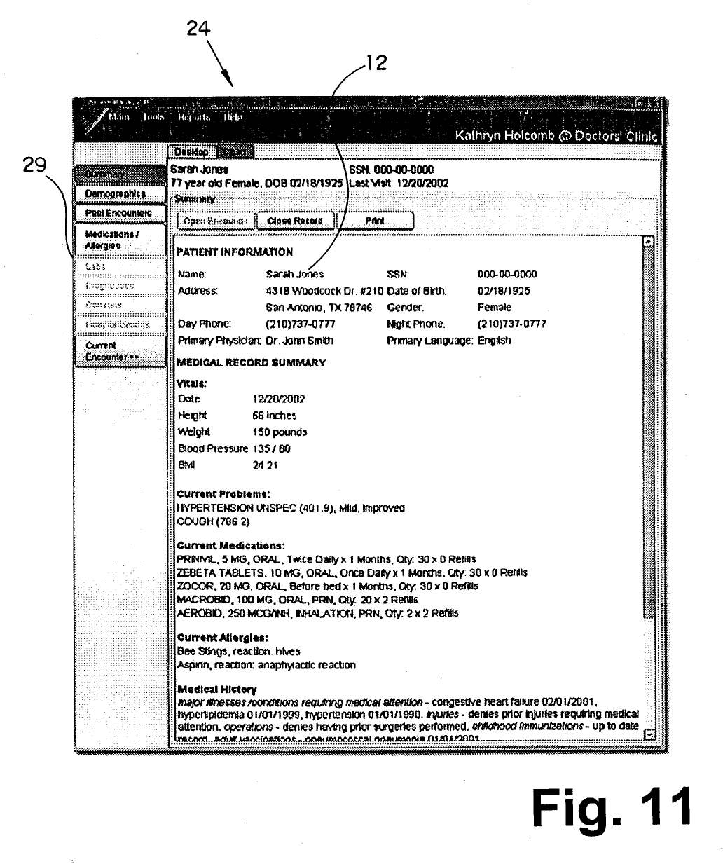

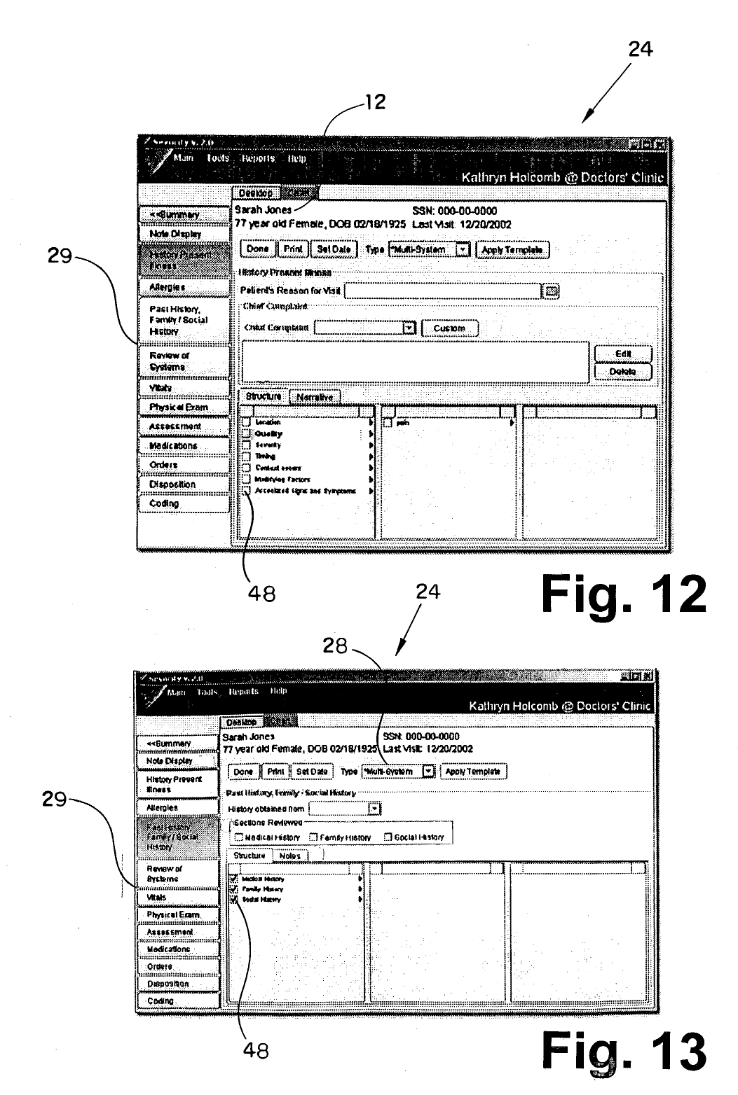

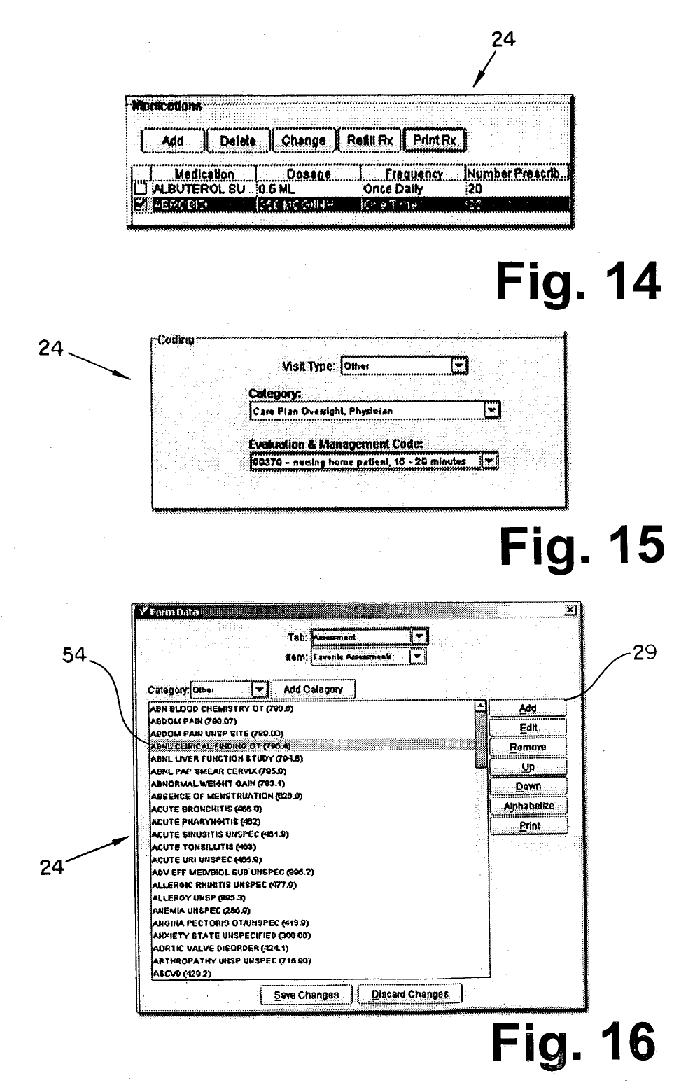

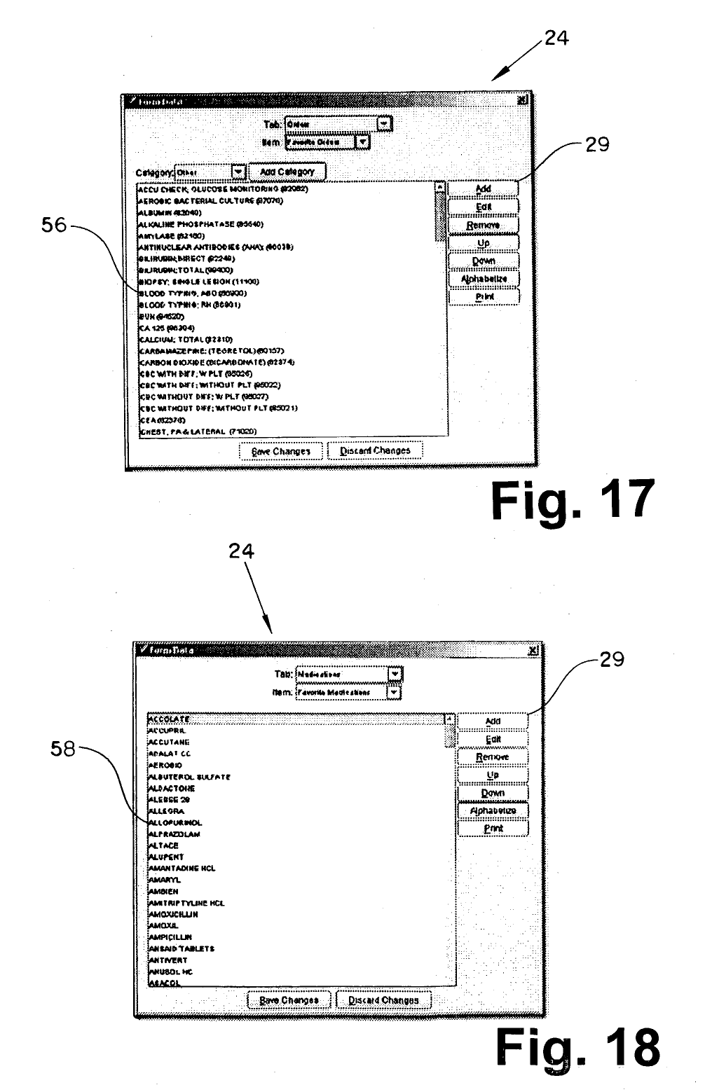

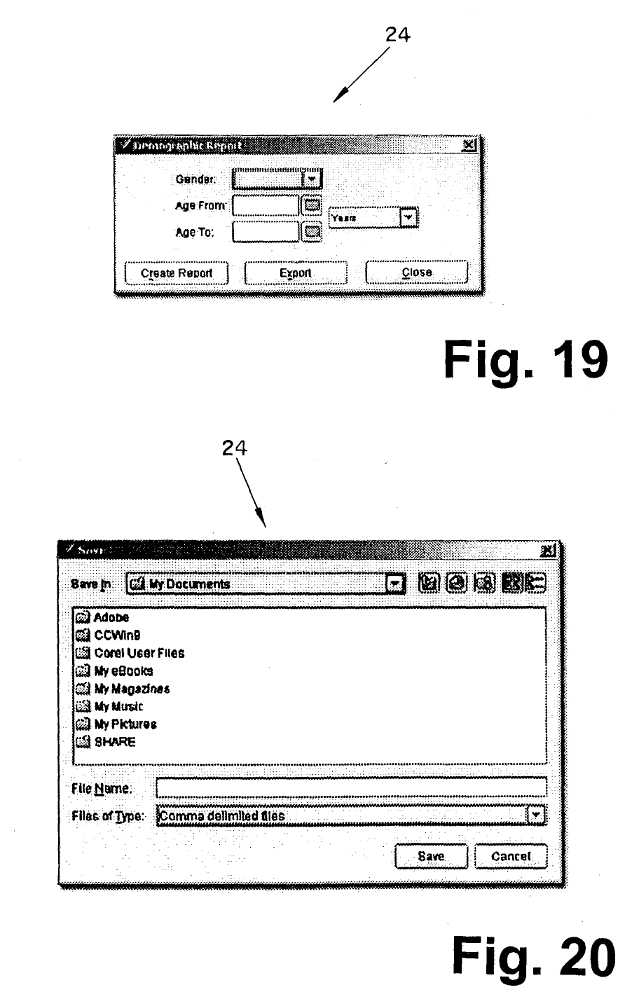

Participating CDOs (14) may download software from the Internet to begin using the present invention. Referring to FIGS. 3-20, the present invention provides a graphic user interface (GUI) (24) through which subscribers may self-register within the system via a website URL address.

Identifying information, such as the address and telephone number of the CDO is entered into the system by CDO personnel (20). Once entered, participating CDOs are given access to the services offered by the system. The registering CDO (14) can designate an administrator to establish user identification and access levels for the organization. The present invention allows the CDO to designate the degree of access that each listed employee will be given.

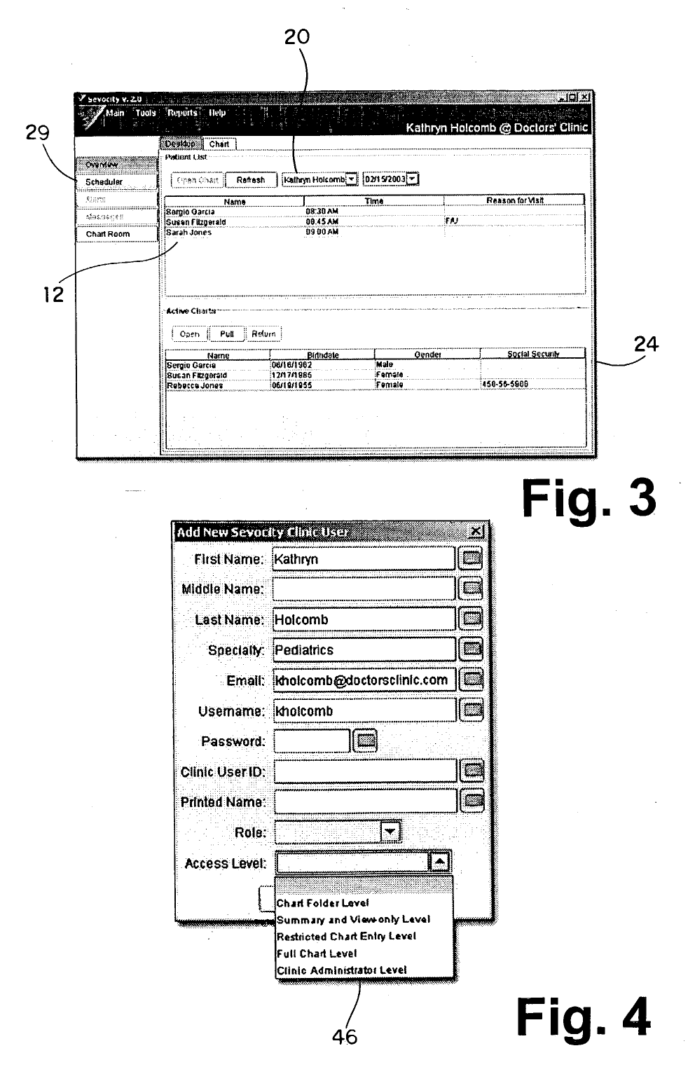

Referring to FIG. 4, the present invention provides one or more assignment screens through which remote station personnel (20) may enter access designations (46). In one embodiment, the present invention allows a user to choose from five predefined access levels. These are chart folder, summary/view only level, restricted chart entry level, and administrator level. Chart folder level entry permits access to patient demographic information only and may be assigned to a receptionist or other CDO office staff.

The summary/view only level allows view only access to patient summary information and chart note information, which is especially useful for on-call physicians from other offices. Restricted chart entry level allows viewing of patient document notes, but restricts viewing of finalizing notes requiring E&M coding. Such access is typically provided to nurses, residents, or medical assistants. Full chart level access permits the viewing of all of the above information as well as the ability to finalize notes requiring E&M coding. Finally, clinic administrator level allows unlimited access to all information accessible through the remote station.

Referring to FIG. 5, in order to access electronic medical records, the CDO physician, nurse, and/or administrator need only input patient personal information into the system. Once requested, the electronic medical record is retrieved, copied, encrypted and transmitted from the database (16) to the CDO (14) through a computer network (18). In one embodiment, a copy of an electronic record is made available to the CDO (14) only upon encryption of the record and entry/confirmation of a unique security identifier or password applicable to one or more remote station personnel (20) having access to a record.

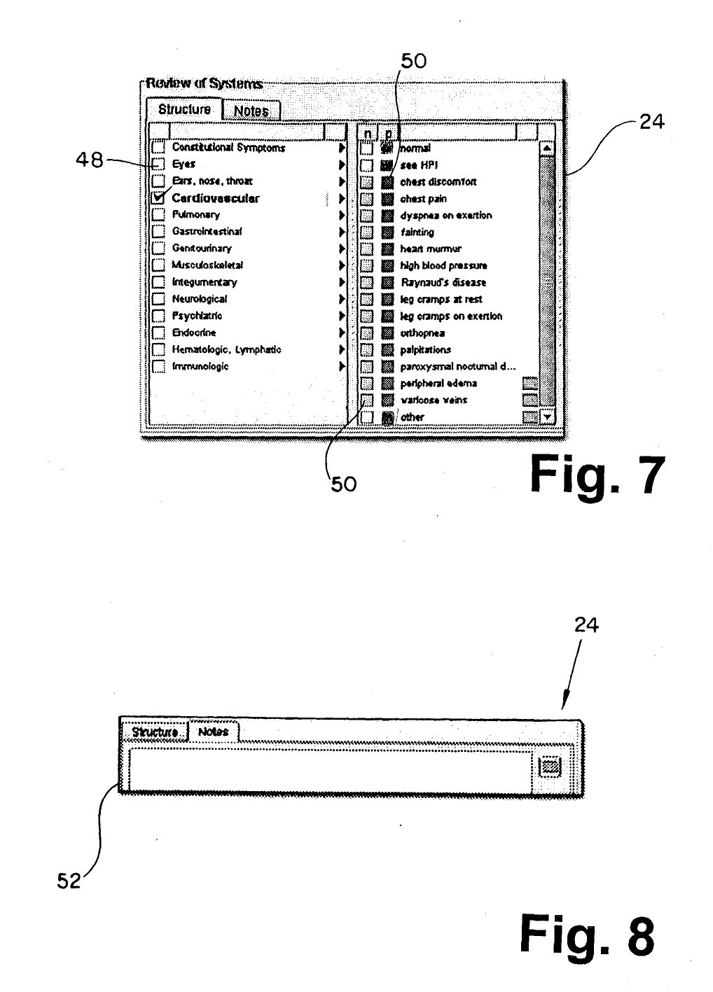

Patients (12) of participating CDOs (14) are entered into the system (10) using a graphical user interface (24). To add a patient to the system, the receptionist or nurse inputs patient personal information such as name, address, social security number, and medical history into the fields provided. The present invention uses the patient's personal information to create an electronic medical record which is then stored upon one or more databases (16) upon transmission to a data center (22). Referring to FIGS. 7 and 8, patient information may be entered/amended through a unique arrangement of boxes (48) (to be checked or unchecked) and/or color schemes (50). For example, white boxes may be used to denote a “normal” condition, green boxes may be used to indicate when a patient (12) denies a particular symptom, and red boxes may be used to indicate that the patient complains of a particular symptom or condition. The present invention further allow information to be entered using one or more free text entry portions (52).

In one embodiment, the present invention allows patient information to be obtained electronically, thus eliminating the need for traditional hard copy forms. Specifically, prior to or upon visiting the health care provider's office (14), the patient is given the option to provide personal information via a unique patient portal (not shown) accessible through the patient's personal computer (26) or through a kiosk (27), both having access to a computer network (18). The kiosk may be located anywhere but, preferably, at or near the CDO in case the patient requires assistance.

This feature of the present invention reduces the burden on CDO receptionists and allows more time to be devoted to patient service. Once patient information has been entered by the user, the information is automatically incorporated into the patient's electronic medical record upon user selection of a confirmation icon (not shown). In one embodiment, the confirmation icon is labeled as “Done” and may be selected by the user upon clicking a mouse button.

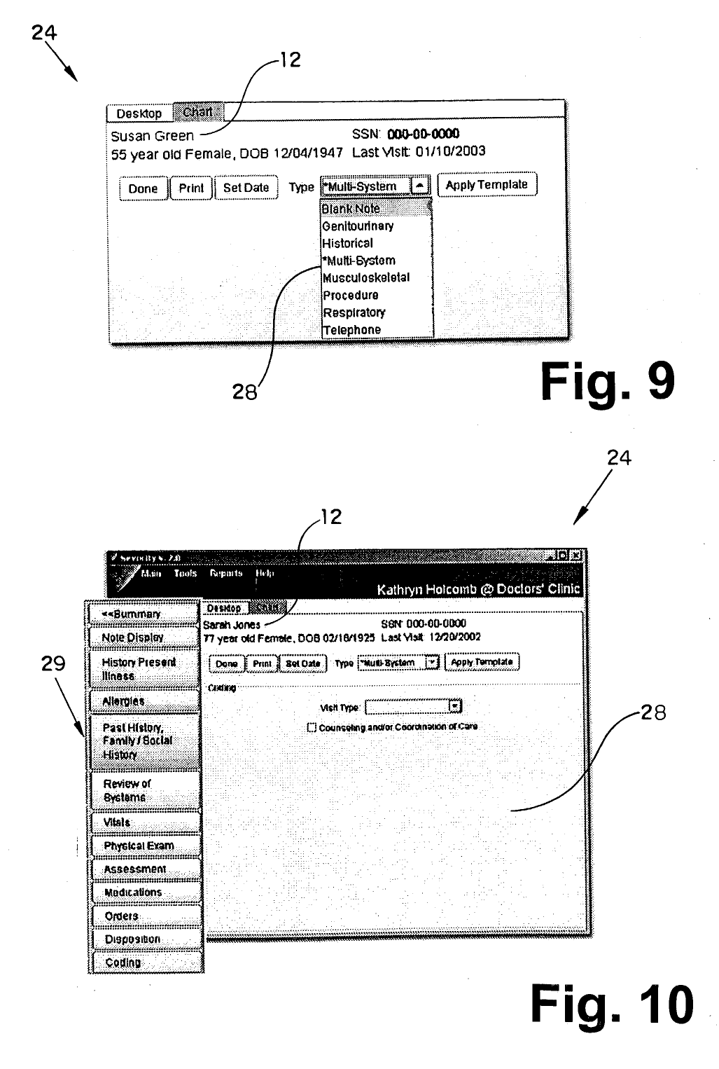

Referring to FIGS. 9 and 10, the present invention allows physicians of participating CDOs to select from an extensive list of templates (28) for documentation purposes. In one embodiment, a plurality of templates are provided according to the nature of the encounter with the patient (12). In one embodiment, the physician or other remote station personnel (20) may select from blank, genitourinary, historical, multi-system, musculoskeletal, procedure, respiratory, and telephone templates residing on the system (10).

The blank template provides a text window for free-text notes. The genitourinary template provides a series of tabs (29) along with an examination portion that supports CMS E&M coding guidelines for genitourinary exams. Further, the exam portion of the template may be gender sensitive based upon the gender identified in the patient's demographic area. The genitourinary template further provides a pediatric tab for use with patients under 18 years of age.

The historical template provided by the present invention includes allergies, PFSH, assessment, and medications tabs. In one embodiment, the remote station personnel (20) may only utilize this template (28) on one occasion for patient's having no other encounter notes on file. The multi-system template provides a series of tabs along with an examination portion that supports CMS E&M coding guidelines or multi-system exams. The multi-system template further provides a pediatric tab for patients under 18 years of age. The musculoskeletal template is similar to the multi-system template except that it provides support for CMS E&M coding guidelines for musculoskeletal exams.

The procedure template provides HPI, allergies, vitals, procedure, assessment, medications, orders, disposition, and coding tabs for use in conjunction with patient medical procedures. The respiratory template is similar to the musculoskeletal template except that it provides support for CMS E&M coding guidelines for respiratory exams. Finally, the telephone template provides tabs for HPI, allergies, PFSH, ROS, vital signs, physical exam, assessment, medications, orders, disposition, and coding.

In the practice of medicine, a physician who has just visited a patient (12) will typically write notes in the patient's file. In the field of medicine, it is customary to use rhetoric such as “head normal” or “chest ok” to describe the patient's condition. The problem is that individual physicians may attribute different meanings to “normal” and “ok”. If the physician does not want to use a standard template, the physician may alter the template for a specific nomenclature. The encounter will then reflect the language of the physician. The use of customizable templates for individual physicians ensures that each patient encounter is accurately entered into the system, as described further below. In one embodiment, the templates of the present invention are designed to be age, gender, and/or practice type specific. This feature of the present invention allows the physician to view and/or enter only that information which is pertinent to the physician's interaction with a particular patient.

Referring to FIGS. 10-15, the present invention updates each electronic medical record subsequent to any patient encounter. An encounter may be any interaction with the patient such as a telephone conversation, consultation, new patient encounter, office visit, physical, procedure, or surgery. As the patient encounter is taking place the physician simply points and clicks on a wireless tablet, desktop personal computer, laptop computer, or touch screen. As the physician moves through the encounter the patient's medical record is updated, prescriptions are sent to the pharmacy (30) and printed for the patient, patient information and educational material may be printed for the patient, and recommended coding is provided to the physician. In one embodiment, electronic prescription information may be encrypted and transmitted to a preferred pharmacy (30) connected to the storage device (16) of the present invention via a computer network (18).

Referring to FIGS. 15-18, the present invention is capable of supporting accurate coding of each medical procedure and/or treatment performed by the physician or other CDO personnel (20). Specifically, the present invention allows the physician to enter the appropriate code for medical services conducted during a given patient encounter including assessments (54), orders (56), and/or recommended medications (58). Once entered, one or more databases (16) of the present invention may be searched automatically or upon user request to 1) verify the proper code has been utilized and/or 2) suggest additional testing, if necessary, to support the code provided by the physician. Coding information may be displayed upon one or more templates and/or printed upon an attached printer (32) utilized by the present invention. This feature of the present invention minimizes payment delays typically caused by inaccurate code entries.

The present invention provides CDOs (14) with easy access to patient medical records. Authorized users (20) may search the database (16) for patient medical records by entering patient personal information into the system (10). For example, many CDOs require patients to make appointments prior to a visit to the physician. The present invention allows the receptionist to enter the name of the patient (12), or other personal information, into the system such that the patient's record may be reviewed prior to his or her visit. Each record that is requested by the CDO (14) is copied, encrypted and transmitted to the requesting provider from the database (16) upon provider entry of a security identifier.

The present invention has been designed to provide CDOs with medical records in a convenient, easy to use format. In fact, the information contained in each medical record is organized to provide physicians with patient information in a format physician's prefer.

In one embodiment, the present invention provides background information such as the patient's insurance carrier, employment situation, primary care physician and emergency contact. Physicians typically review this type of information to ensure that prospective patients will meet their financial obligations to the CDO. Additionally, the present invention automatically confirms the payor eligibility information interfacing to existing verification services where available.

Referring to FIGS. 3-20, in addition to background information, the present invention allows physicians or other authorized personnel to review the patient's prior medical history and/or previous patient encounters. For example, the present invention provides a host of informational screens (24) containing information such as the patient's gender, date of birth, allergies, prescriptions, surgeries, family illnesses, trauma, mental health information, etc. Further, the present invention provides a report generating capability useful for physicians, nurses, and other CDO personnel (20). Specifically, the GUI (24) of the present invention provides CDO personnel with at least one report generating screen capable of receiving patient parameters into the system and searching storage device records in order to compile one or more reports. For example, if a physician wished to know how many patients under his or her care are female, over 40 years of age, and have not had a mammogram screening, he or she need only input such parameters into the GUI (24) of the present invention. The storage device (16) is then searched for the information and a report is generated. This report may be presented/displayed on screen in any number of known document formats, or electronically exported to one or more locations via the computer network.

The present invention maintains one or more databases (16) containing patient guidelines. In one embodiment, a Health Employer Data and Information Set (HEDIS) rules engine is utilized to catalog and store recommended treatments and/or procedures for individual patients given the patient's age, sex, medical history, etc. The present invention is capable of accessing these guidelines in order to remind the physician, nurse, administrator and/or patient of recommended treatments or procedures. Thus, the present invention improves the flow of information between the parties and ensures that the patient is fully informed regarding recommended medical procedures/treatments. As a result, the patient is better able to make informed decisions regarding his or her healthcare. In one embodiment, remote station personnel, the patient, or both, may be informed of recommended treatments and/or procedures through a secure messaging device including but not limited to encrypted signal carried over a computer network, a confidential hardcopy document, a telephone call over a secured telephone line and/or wireless or satellite transmission over a secure channel.

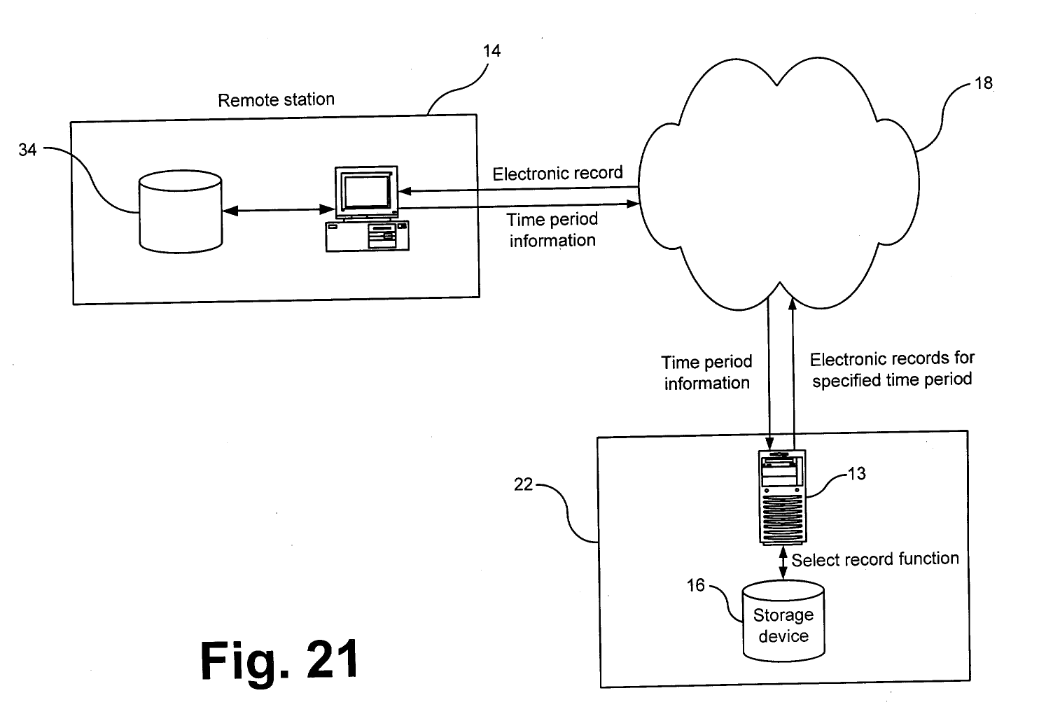

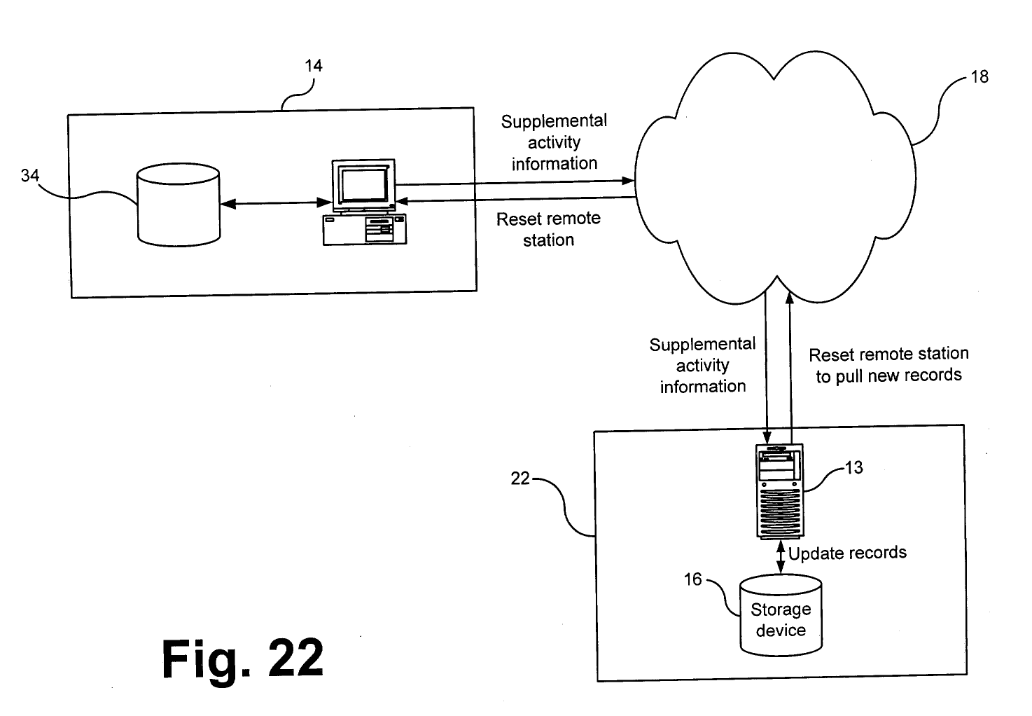

Referring to FIGS. 21 and 22, in one embodiment, CDOs (14) may be configured for seamless backup capability should the data center (22) lose capacity or equipment function. CDOs wishing to take part need only advise data center personnel of same and request a time period for which backup capability is desired. Electronic records may then be copied from the storage device (16) of the present invention and temporarily stored upon a remote storage unit (34) accessible by the requesting CDO. The volume of electronic records to be remotely stored being dependant on the time period requested by the CDO. Further, in one embodiment, only records pertaining to patient's serviced by the requesting CDO are provided for backup storage. This feature of the present invention assists in maintaining the confidentiality of each patient record.

In one embodiment, the remote storage unit(s) (34) utilized by the present invention to provide seamless backup capability are 1) located at the CDO, 2) electrically connected to one or more remote computer stations, and 3) electrically connected to the storage device (16) through a data transmission network (18). This configuration allows the remote computer station to be automatically or manually reset such that electronic records may be drawn from the remote, temporary storage unit (34) when the data center or its systems are unavailable.

Upon expiration of the requested time period or availability of the data center (22) systems, the remote computer system may be automatically or manually reset to, once again, draw electronic records from the storage device (16). At this time, all activity (i.e., patient encounters resulting in amendments or updates to the records held upon the remote storage device (34)) is transmitted to the storage device (16). This allows for permanent storage of any new information as well as updates to records previously held upon the storage device. In one embodiment, records held upon the requesting CDO's remote storage unit (34) are periodically updated with current records provided through the data transmission network (18) from the storage device (16).

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

We claim:

1. A method of managing electronic records comprising the steps of:
providing an electronic records management system comprising at least one object oriented storage device connected to one or more remote computer stations through a data transmission network;
providing a web-based graphic user interface through which remote station personnel may enter identifying information relating to said remote station;
receiving and storing said identifying information upon said storage device;
receiving personal information; and
storing said personal information upon said storage device and creating an electronic record, an electronic copy of said record being accessible by said remote station through said data transmission network upon encryption of said record and entry of one or more security identifiers by remote station personnel.

2. The method of claim 1, wherein said remote station comprises a computer system located at a health care delivery organization apart from said storage device, said electronic records stored upon said storage device comprising medical records pertaining to one or more patients of said remote health care delivery organizations.

3. The method of claim 2, wherein said graphic user interface further comprises an access assignment screen upon which remote station personnel may define levels of access to medical records to be afforded to remote station personnel.

4. The method of claim 3, wherein said personal information comprises health information and demographic information provided to said health care delivery organization.

5. The method of claim 4, wherein said personal information is provided by a patient prior to an office visit, said personal information being 1) entered into said patient's personal computer and transmitted to said storage device through said data transmission network or 2) entered through a kiosk and transmitted to said storage device through said data transmission network.

6. The method of claim 4, wherein said graphic user interface further comprises one or more templates for use by said remote station personnel during an encounter with said patient.

7. The method of claim 6, wherein encounter information entered upon one or more of said templates is automatically utilized to update said patient's electronic record upon said storage device.

8. The method of claim 6, wherein said storage device further contains coding information designed to assist remote station personnel in identifying assessments, orders and/or medications for said patient before, during and/or after an encounter, said coding information being displayable upon each of said templates.

9. The method of claim 6, wherein said templates are customizable by said remote station personnel.

10. The method of claim 6, wherein said templates are age, gender, and/or practice type specific.

11. The method of claim 8, further comprising the additional step of:
searching said coding information held upon said storage device in order to advise whether the proper code has been entered by the remote personnel.

12. The method of claim 2, further comprising the additional steps of:
storing health guideline information upon said storage device, said guideline information containing recommended treatments and/or procedures for patients meeting one or more predetermined criteria;
searching said storage device and retrieving recommended treatments and/or procedures for one or more patients; and
providing a secure messaging means for alerting said remote personnel and/or said patient as to said recommended treatments and/or procedures.

13. The method of claim 2, further comprising the additional steps of:
determining if seamless backup capability is desirable if and when said electronic record system is unavailable or inoperative;
if seamless backup capability is desirable, determining a time period for which such backup capability is desirable; and
providing one or more remote storage units capable of retaining electronic records throughout said time period such that said remote station may pull electronic medical records from said storage unit, said storage unit being 1) located at said remote station, 2) electrically connected to said remote computer system, and 3) electrically connected to said storage device through said data transmission network; and
resetting said remote computer station to retrieve electronic records from said storage unit during said time period or until said system becomes available.

14. The method of claim 13, further comprising the additional steps of:
upon expiration of said time period or availability of said electronic records system, transmitting all supplemental activity information held upon said storage unit(s) to said storage device through said data transmission network;
updating said electronic records held upon said storage device in light of said supplemental activity information; and
resetting said remote computer station to retrieve electronic records from said storage device through said data transmission network.

15. The method of claim 2, wherein said graphic user interface further comprises a report generation screen upon which said remote station personnel may enter patient parameters.

16. The method of claim 15, further comprising the additional steps of:
utilizing said patient parameters, searching said storage device for electronic records matching said parameters;
compiling the number of patients matching said parameters and generating a report therefrom; and
displaying the results of said search.

17. The method of claim 6, further comprising the additional step of:
providing means for producing one or more coding statements associated with said encounter.

18. The method of claim 6, further comprising the additional step of:
providing means for producing one or more prescriptions associated with said encounter.

19. The method of claim 18, further comprising the additional step of:
transmitting a secure electronic copy of said prescription to a pharmacy system, said pharmacy system being electrically connected to said data transmission network.

20. A method of managing electronic medical records comprising the steps of:
providing an electronic records management system comprising at least one object oriented storage device connected to one or more remote computer stations through a data transmission network, said remote computer station comprising at least one computer system located at a health care delivery organization apart from said storage device;
providing a web-based graphic user interface through which remote station personnel may enter identifying information relating to said remote station, said graphic user interface further comprising one or more templates for use by said remote station personnel during an encounter with a patient, said templates being age, gender, and/or practice type specific;
receiving and storing said identifying information upon said storage device;
receiving personal information, said personal information comprising health information and demographic information provided to said health care delivery organization; and
storing said personal information upon said storage device and creating an electronic record, an electronic copy of said record being accessible by said remote station through said data transmission network upon encryption of said record and entry of one or more security identifiers by remote station personnel.

21. An electronic records management system comprising:
at least one object oriented storage device coupled to one or more remote computer stations through a data transmission network;
a web-based graphic user interface through which remote station personnel may enter identifying information relating to said remote station;
a processing unit, coupled to said storage device, for:
receiving and storing said identifying information upon said storage device;
receiving personal information; and
storing said personal information upon said storage device and creating an electronic record, an electronic copy of said record being accessible by said remote station through said data transmission network upon encryption of said record and entry of one or more security identifiers by remote station personnel.

22. The electronic records management system of claim 21, wherein said remote station comprises a computer system located at a health care delivery organization apart from said storage device, said electronic records stored upon said storage device comprising medical records pertaining to one or more patients of said remote health care delivery organizations.

23. The electronic records management system of claim 22, wherein said graphic user interface further comprises an access assignment screen upon which remote station personnel may define levels of access to medical records to be afforded to remote station personnel.

24. The electronic records management system of claim 21, wherein said personal information comprises health information and demographic information provided to said health care delivery organization.

25. The electronic records management system of claim 24, wherein said personal information is provided by said first customer prior to an office visit, said personal information being 1) entered into said first customer's personal computer and transmitted to said storage device through said data transmission network or 2) entered through a kiosk and transmitted to said storage device through said data transmission network.

26. The electronic records management system of claim 24, wherein said graphic user interface further comprises one or more templates for use by said remote station personnel during an encounter with said first customer.

27. The electronic records management system of claim 26, wherein said storage device further comprises coding information designed to assist remote station personnel in identifying assessments, orders and/or medications for said patient before, during and/or after an encounter, said coding information being displayable upon each of said templates.

28. The electronic records management system of claim 26, wherein said templates are age, gender, and/or practice type specific.

29. The electronic records management system of claim 27, wherein said processing unit is for:
reviewing said coding information and advising whether the proper code has been entered by the remote personnel.

30. The electronic records management system of claim 22, wherein said processing unit is for:
storing health guideline information upon said storage device, said guideline information containing recommended treatments and/or procedures for patients meeting one or more predetermined criteria;
searching said storage device and retrieving recommended treatments and/or procedures for one or more patients; and
alerting said remote personnel and/or said patient as to said recommended treatments and/or procedures via said data transmission network.

31. The electronic records management system of claim 22, wherein said processing unit is for:
determining if seamless backup capability is desirable if and when said electronic record system is unavailable or inoperative;
if seamless backup capability is desirable, determining in a time period for which such backup capability is desirable; and
providing one or more remote storage units capable of retaining electronic records throughout said time period such that said remote station may pull electronic medical records from said storage unit, said storage unit being 1) located at said remote station, 2) electrically connected to said remote computer system, and 3) electrically connected to said storage device through said data transmission network; and
resetting said remote computer station to retrieve electronic records from said storage unit during said time period or until said system becomes available.

32. The electronic records management system of claim 31, wherein said processing unit is for:
transmitting all supplemental activity information held upon said storage unit(s) to said storage device through said data transmission network upon expiration of said time period or availability of said electronic records system;
updating said electronic records held upon said storage device in light of said supplemental activity information; and
resetting said remote computer station to retrieve electronic records from said storage device through said data transmission network.

33. The electronic records management system of claim 22, wherein said graphic user interface further comprises a report generation screen upon which said remote station personnel may enter patient parameters.

34. The electronic records management system of claim 33, wherein said processing unit is for:
utilizing said patient parameters, searching said storage device for electronic records matching said parameters;
compiling the number of patients matching said parameters and generating a report therefrom; and
displaying the results of said search.

35. The electronic records management system of claim 22, further comprising means for producing one or more coding statements.

36. The electronic records management system of claim 22, further comprising means for producing one or more prescriptions.

37. The electronic records management systems of claim 36, wherein said processing unit is for:
transmitting a secure electronic copy of said prescription to a pharmacy system, said pharmacy system being electrically connected to said data transmission network.
